(19) United States
(12) Patent Application Publication
(10) Pub. No.: US 2026/0101107 A1
(43) Pub. Date: Apr. 9, 2026

(54) IMAGE PROCESSING METHOD, IMAGE PROCESSING APPARATUS, IMAGE PROCESSING SYSTEM, AND STORAGE MEDIUM

(71) Applicant: CANON KABUSHIKI KAISHA, Tokyo (JP)

(72) Inventors: Takashi ONIKI, Tochigi (JP); Norihito HIASA, Tochigi (JP)

(21) Appl. No.: 19/310,016

(22) Filed: Aug. 26, 2025

(30) Foreign Application Priority Data
Oct. 3, 2024 (JP) 2024-174538

(51) Int. Cl. H04N 23/68; H04N 23/617

(52) U.S. Cl. CPC H04N 23/683; H04N 23/617

(57) ABSTRACT

Image processing methods, image processing apparatuses, image processing systems, and storage media are provided herein. One or more image processing methods for processing an image obtained via an optical system and an image sensor may include acquiring a moving amount of the image sensor, generating a plurality of first partial images which include an optical axis position obtained by dividing the image, generating a plurality of partial output images based on first partial images using a neural network, and generating an output image by combining the plurality of partial output images using the moving amount.

### BACKGROUND

### Field of the Technology

The aspect of the disclosure relates to one or more embodiments of an image processing method, an image processing apparatus, an image processing system, and a storage medium.

### Description of the Related Art

Japanese Patent Application Laid-Open No. 2020-61129 discloses a method for correcting an image blur using a convolutional neural network (CNN). The method disclosed in Japanese Patent Application Laid-Open No. 2020-61129 inverts a part of an image and performs correction processing for the inverted partial image.

### SUMMARY

One or more embodiments of an image processing method for processing an image obtained via an optical system and an image sensor may include acquiring a moving amount of the image sensor, generating a plurality of first partial images which include an optical axis position obtained by dividing the image, generating a plurality of partial output images based on first partial images using a neural network, and generating an output image by combining the plurality of partial output images using the moving amount. One or more embodiments of an image processing apparatus corresponding to the above image processing method also constitute another aspect of the disclosure. One or more embodiments of an image processing system may include one or more image processing apparatus in accordance with one or more other aspects of the disclosure. A storage medium storing a program that causes a computer to execute the above one or more image processing methods also constitutes another aspect of the disclosure.

Features of the disclosure will become apparent from the following description of embodiments with reference to the attached drawings. The following description of embodiments is described by way of example.

### BRIEF DESCRIPTION OF THE DRAWINGS

FIG. 1 is a block diagram of an image processing system according to a first embodiment.

FIG. 2 is an external view of the image processing system according to the first embodiment.

FIG. 3 is a flowchart illustrating a training method of a machine learning model according to the first embodiment.

FIG. 4 illustrates a flow of training a neural network according to the first embodiment.

FIGS. 5A and 5B explain a training range for a captured image according to the first embodiment.

FIG. 6 is a flowchart illustrating corrected-image generation processing according to the first embodiment.

FIG. 7 illustrates a quadrant image in the first embodiment.

FIGS. 8A, 8B, 8C, and 8D explain corrected quadrant images in the first embodiment.

FIGS. 9A, 9B, 9C, and 9D illustrate corrected quadrant images in a case where there is no movement of an image sensor in the first embodiment.

FIG. 10 is a block diagram of an image processing system according to a second embodiment.

FIG. 11 is an external view of the image processing system according to the second embodiment.

FIG. 12 illustrates a quadrant image according to the second embodiment.

FIG. 13 is a block diagram of the image processing system according to a third embodiment.

FIG. 14 is a flowchart illustrating corrected-image generation processing according to the third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

Before the specific embodiments are described, one example according to the disclosure will be described. This embodiment may divide a captured image captured using an optical system into a plurality of divided images. Each of the plurality of divided images may be divided so as to include an optical axis position. The divided images are further divided after inversion processing. Correction processing is performed for the divided images. The correction processing is processing for reducing blurs caused by an optical system, and can use a machine learning model. The estimated images corrected in this way are combined to generate a corrected image corresponding to the divided images. Next, inversion processing is performed, and the corrected divided images are combined based on the optical axis position. Thus, in dividing the captured image, division processing is performed so that each divided image includes the optical axis position, and in combining the images after the correction processing, they are combined based on the optical axis position.

Here, the blurs caused by the optical system include blurs due to aberration, diffraction, and defocus, the action of an optical low-pass filter, and pixel opening deterioration of an image sensor. The machine learning model includes, for example, a neural network, genetic programming, Bayesian network, etc. The neural network includes a CNN, Generative Adversarial Network (GAN), Recurrent Neural Network (RNN), etc.

This embodiment is applicable not only to sharpening processing, but also to image processing such as contrast improvement, luminance improvement, defocus blur conversion, and lighting conversion.

Thus, the correction processing based on the optical-axis shift from the image center can provide a high correction effect even for images obtained by capturing an image using the image sensor in a moved state.

In the following description, the step at which the weights of the machine learning model are updated will be referred to as a training phase, and the step at which a corrected image is generated by the machine learning model using the learned weights will be referred to as an estimation phase.

### First Embodiment

A description will now be given of an image processing system according to this embodiment. In this embodiment, blur in a captured image is sharpened (blur correction processing) using a machine learning model. The blur to be sharpened is the blur caused by aberration, diffraction, and an optical low-pass filter that occurs in the optical system. However, the effect of the disclosure can be obtained similarly in sharpening a blur caused by pixel opening, defocus, and shake. The effect of the disclosure can be obtained similarly for tasks other than blur sharpening.

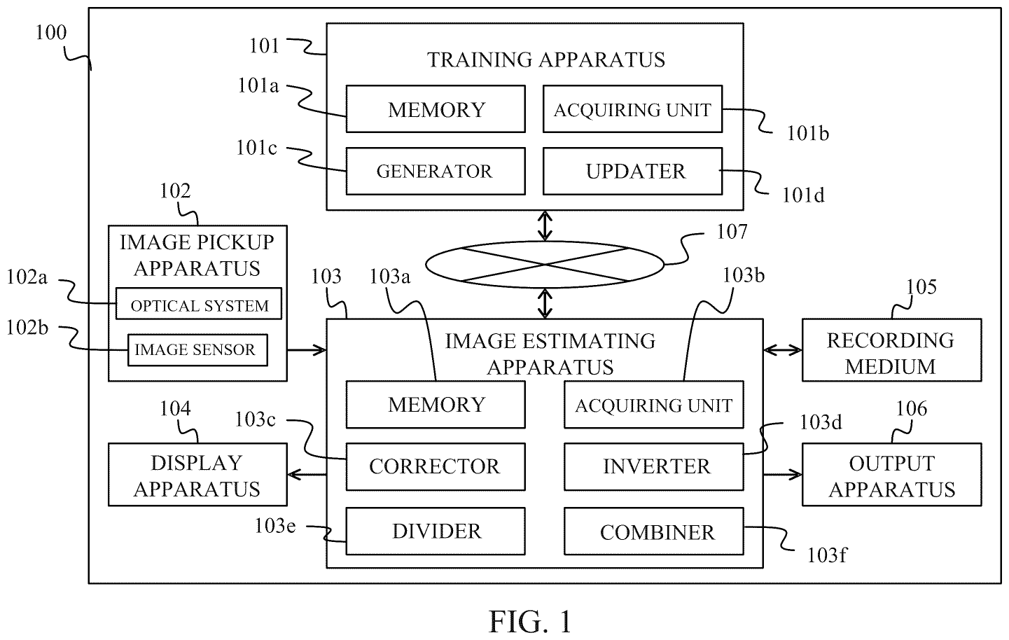

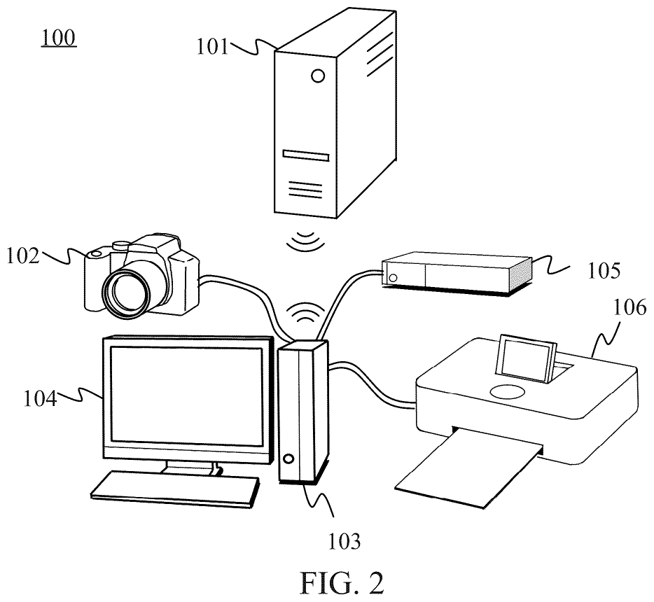

FIG. 1 is a block diagram of an image processing system 100 according to this embodiment. FIG. 2 is an external view of the image processing system 100. The image processing system 100 includes a training apparatus 101, an image pickup apparatus 102, an image estimation apparatus 103, a display apparatus 104, a recording medium 105, an output apparatus 106, and a network 107.

The training apparatus 101 is an image processing apparatus that executes training step, and includes a memory (storage unit) 101a, an acquiring unit 101b, a generator 101c, and an updater 101d. The acquiring unit 101b acquires a training image and a ground truth image. The generator 101c inputs the training image into a multilayer neural network to generate an output image. The updater 101d updates the weights of the neural network based on the error between the output image generated by the generator 101c and the ground truth image. Details of the training step will be described later using a flowchart. Information on the weights obtained by training is stored in the memory 101a.

The image pickup apparatus 102 includes an optical system 102a and an image sensor 102b. The optical system 102a condenses light incident on the image pickup apparatus 102 from the object space. The image sensor 102b receives (photoelectrically converts) an optical image (object image) formed via the optical system 102a to acquire a captured image. The image sensor 102b includes, for example, a Charge Coupled Device (CCD) sensor or a Complementary Metal-Oxide Semiconductor (CMOS) sensor. The captured image acquired by the image pickup apparatus 102 contains blurs due to aberration and diffraction of the optical system 102a and noise due to the image sensor 102b.

The image estimation apparatus 103 is an image processing apparatus that executes the estimation step (or an image processing apparatus for processing an image), and includes a memory 103a, an acquiring unit 103b, a corrector 103c, an inverter 103d, a divider 103e, and a combiner 103f. The image estimation apparatus 103 performs blur correction (deblurring) for the captured image to generate an estimated image. A multilayer neural network is used for the blur correction (image processing), and weight information is read from the memory 103a. The weights are obtained by training using the training apparatus 101, and the image estimation apparatus 103 reads out the weight information from the memory 101a via the network 107 in advance and stores it in the memory 103a. The stored weights may be the numerical values or may be in an encoded format. Details regarding the update of the network parameters and the blur correction processing using the neural network will be described later.

An output image is output to at least one of the display apparatus 104, the recording medium 105, and the output apparatus 106. The display apparatus 104 includes, for example, a liquid crystal display or a projector. The user can perform editing work while checking the image being processed via the display apparatus 104. The recording medium 105 includes, for example, a semiconductor memory, a hard disk drive, a server on the network, etc. The output apparatus 106 includes, for example, a printer. The image estimation apparatus 103 has a function of performing development processing and other image processing, as necessary.

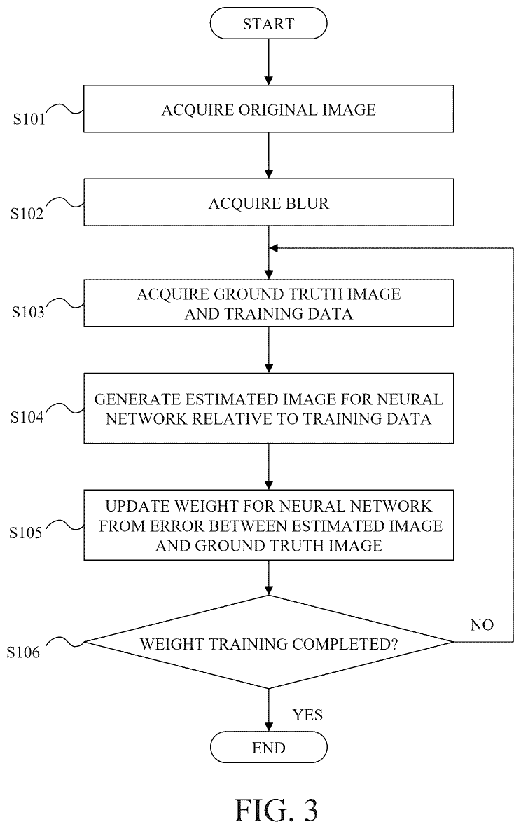

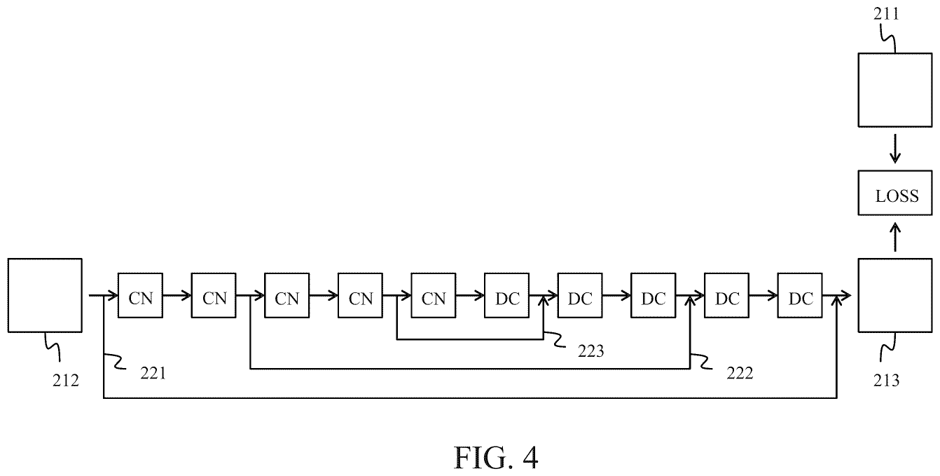

A description will now be given of a training method for the machine learning model (a trained-model generating method) executed by the training apparatus 101 according to this embodiment. FIG. 3 is a flowchart illustrating a training method of a machine learning model. Each step in FIG. 3 is mainly executed by the acquiring unit 101b, the generator 101c, or the updater 101d in the training apparatus 101. FIG. 4 illustrates a flow of training a neural network (machine learning model), and illustrates the flow from step S104 to S105 in FIG. 3.

In step S101, the acquiring unit 101b acquires an original image (object image). In this embodiment, the original image is a high-resolution (high-quality) image with few blurs due to aberration or diffraction of the optical system 102a. A plurality of original images are acquired, which are images of various objects, that is, images having edges of various strengths and directions, textures, gradations, flat parts, etc. The original image may be a real image or an image generated by Computer Graphics (CG).

The original image may have a signal value higher than the luminance saturation value of the image sensor 102b. This is because even some actual objects do not fall within the luminance saturation value when they are captured by the image pickup apparatus 102 under a specific exposure condition. A high-resolution captured image is generated by reducing the original image and clipping the signal at the luminance saturation value of the image sensor 102b. In particular, in a case where a real image is used as the original image, blurs have already occurred due to aberration and diffraction, so reducing the image can reduce the influence of blurs and provide a high-resolution (high-quality) image. In a case where the original image contains sufficient high-frequency components, reduction is not necessary. The original image may have noise components. In this case, the noise contained in the original image can be considered to be the object, so the noise in the original image is not particularly problematic.

In step S102, the acquiring unit 101b acquires the blurs used to perform an imaging simulation described later. First, an imaging condition corresponding to the lens state (states of the zoom, aperture value (F-number), and focal length) of the optical system 102a is acquired. Then, the blurs determined by the imaging condition and the image position are acquired. A moving amount of the image sensor 102b may be set as one of the calculation conditions in determining the image position. Here, the blur may be expressed by a point spread function (PSF) or optical transfer function (OTF) of the optical system 102a. The blur can be obtained by optical simulation or measurement of the optical system 102a. The blur due to the lens state, image height, azimuth aberration, and diffraction, which differ for each original image, is obtained. Thereby, an imaging simulation corresponding to a plurality of imaging conditions, image heights, and azimuths can be performed. Components such as an optical low-pass filter included in the image pickup apparatus 102 may be added to the blur, as necessary.

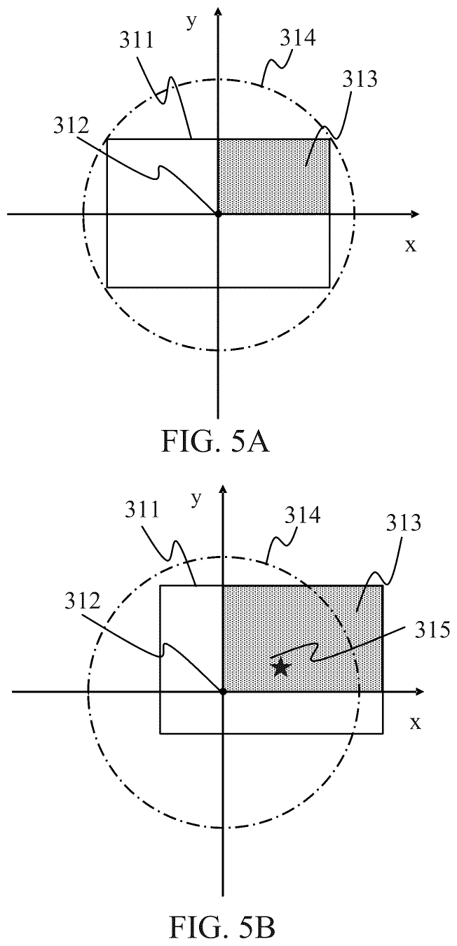

FIGS. 5A and 5B explain a training range for the captured image. In FIGS. 5A and 5B, a solid rectangle indicates a captured image 311, a black dot indicates an optical axis position (reference point) 312 of the optical system 102a, a hatched area indicates a training range 313, an alternate long and short dash line circle indicates an image circle 314 with the diagonal of the image sensor 102b as a diameter, and a star indicates an image center 315. FIG. 5A illustrates the case where image sensor 102b does not move, and FIG. 5B illustrates the case where image sensor 102b does move.

In FIG. 5A, the image center 315 and optical axis position 312 coincide with each other, so the image center 315 is not illustrated. In a coaxial optical system, the aberration will be rotationally symmetric about the optical axis. An optical low-pass filter also exists, such as horizontal (vertical) two-point separation and four-point separation, but they are symmetric about the X-axis and Y-axis. Therefore, in a case where the second quadrant is inverted about the Y-axis, the fourth quadrant is inverted about the X-axis, and the third quadrant is inverted about the X and Y axes, they can be processed as the first quadrant.

Therefore, in a case where the image sensor 102b does not move as in FIG. 5A, only the first quadrant needs to be trained, and limiting the training range in this way can reduce a data amount. On the other hand, in FIG. 5B, the image sensor 102b moves, and the image center 315 is located on the positive side in both the X-axis and Y-axis directions from the optical axis position 312. Thus, in a case where the image sensor 102b moves, it is necessary to set a wider range as the training target than when the image sensor 102b does not move, as in the training range 313 in FIG. 5B. This embodiment acquires a maximum moving amount of the image sensor 102b in the X-axis and Y-axis directions, and sets a range expanded by the moving amount as the training target range. Even when the image sensor 102b moves, the symmetry with respect to the optical axis position 312 is similar to that in FIG. 5A, so only the first quadrant part is trained on the premise that the inversion processing is performed.

In step S103, the generator 101c generates a ground truth patch (ground truth image) and a training patch (training data). A plurality of ground truth patches and training patches are generated, and one or more patches are generated corresponding to one original image. In this embodiment, the ground truth patch and the training patch are images of the same object. This embodiment uses a plurality of combinations of ground truth patches and training patches as training data. A patch refers to an image having a predetermined number of pixels (such as 64×64 pixels, etc.). The number of pixels of the ground truth patch and the number of pixels of the training patch may not coincide. This embodiment uses mini-batch training to learn the weights of the multi-layered neural network. Therefore, in step S103, a plurality of sets of ground truth patches and training patches are generated. However, the disclosure is not limited to this example, and online training or batch training may be used. In this embodiment, the original image is an undeveloped raw image, and the ground truth patch and the training patch are also raw images. However, the disclosure is not limited to this example, and may be an image after development, or a feature map obtained by converting an image as described later. The position of the partial region refers to the center of the partial region.

In step S104, the generator 101c inputs a training patch 212 illustrated in FIG. 4 into a multi-layer neural network to generate an estimated patch (estimated image) 213. For mini-batch training, an estimated patch 213 corresponding to the multiple training patches 212 is generated. The estimated patch 213 has sharpness higher than that of the training patch 212, and ideally matches the ground truth patch 211. Although the disclosure uses the neural network configuration illustrated in FIG. 4 in this embodiment, the disclosure is not limited to this example.

In FIG. 4, CN represents a convolution layer, and DC represents a deconvolution layer. Both CN and DC calculate the convolution of the input and the filter and the sum with the bias, and nonlinearly transforms the result using the activation function. The initial values of each component of the filter and the bias are arbitrary, and are determined by random numbers in this embodiment. The activation function may include, for example, Rectified Linear Unit (ReLU) and a sigmoid function. The output of each layer except the final layer is called a feature map. Skip connections 222 and 223 combine feature maps output from discontinuous layers. The feature maps may be combined by element-by-element summation or by concatenation in the channel direction. This embodiment adopts element-by-element summation. The skip connection 221 sums the residual estimated from a training patch 212 and a ground truth patch 211 with the training patch 212 to generate an estimated patch 213. The estimated patch 213 is generated for each of the multiple training patches 212.

In step S105, the updater 101d updates the weights of the neural network based on an error between the estimated patch 213 and the ground truth patch 211. Here, the weights include the filter components and biases of each layer. Backpropagation is used to update the weights, but the disclosure is not limited to this example. For mini-batch training, errors between the plurality of ground truth patches 211 and the corresponding estimated patches 213 are calculated, and the weights are updated. A loss function may use, for example, the L2 norm or the L1 norm.

In step S106, the updater 101d determines whether the training has been completed. Completion can be determined based on whether the number of iterations of training (updating the weights) has reached a specified value, or whether a change amount in the weights at the time of updating is smaller than a specified value. In a case where the updater 101d determines that the training has been completed, it stores the weight information in the memory 101a and this flow ends. In a case where the updater 101d determines that the training has not yet been completed, i.e., that the training has been incomplete, it executes the processing of step S103 and obtains a plurality of new ground truth patches and training patches.

The training method according to this disclosure has been discussed above, but training may be performed by adding data other than images to the training data. Examples of the data to be added include a map representing image plane coordinate information (image plane coordinate map) and a map representing noise information (noise map). The image plane coordinate map is a map representing image plane coordinates corresponding to the blurs acting on the blurred image. Since the image sensor 102b is disposed on the image plane, the image plane coordinates are synonymous with the position on the image sensor 102b. The noise map is a map representing the noise intensity of the blurred image. Noise refers to noise (shot noise, etc.) generated by the image sensor 102b (or another image sensor that can be combined with the optical system 102a).

A plurality of blurred images stored in the memory 101a contain noises of a variety of intensities that may occur in performing imaging using the optical system 102a. In a case where the blurred image is obtained by actual imaging, the noise intensity can be obtained from the image sensor that is used for imaging and the ISO speed during imaging. In a case where the blurred image is generated by imaging simulation, the intensity of the added noise is known, so the noise intensity can be obtained. The noise intensity can be expressed by the standard deviation of noise for a specific luminance. A second map may be generated for each channel by approximating the variance of noise for luminance with n (where n is a natural number) using the following equation, where each coefficient is the noise intensity. By inputting the noise map to the CNN, there is an advantage that the CNN can easily distinguish between noise and the object. The number of pixels in the noise map is determined based on the number of pixels in the blurred image. In a case where there is no noise in the ground truth image, the CNN is trained to perform sharpening and denoising at the same time. In a case where there is noise in the ground truth image that is of the same intensity as the noise in the blurred image and is correlated with it, the CNN is trained to perform blur sharpening with noise fluctuations suppressed.

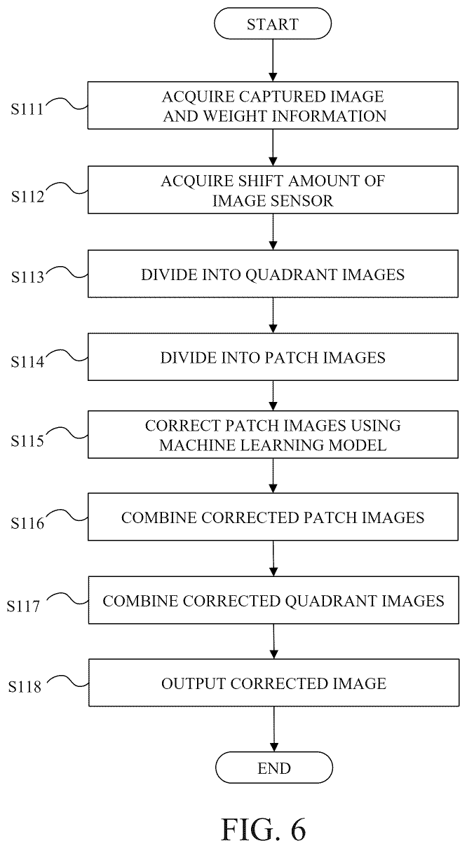

A description will now be given of deblurred-image (estimated-image) generation processing (blur correction process) performed by the image estimation apparatus 103 according to this embodiment. FIG. 6 is a flowchart illustrating the corrected-image generation processing. Each step in FIG. 6 is mainly executed by the acquiring unit 103b, corrector 103c, inverter 103d, divider 103e, or combiner 103f in the image estimation apparatus 103.

In step S111, the acquiring unit 103b acquires a captured image and weight information. The captured image is an undeveloped raw image, similar to training, and in this embodiment, is transmitted from the image pickup apparatus 102. The weight information is the weight of the machine learning model transmitted from the training apparatus 101 and stored in the memory 103a.

In step S112, the acquiring unit 103b acquires a moving amount (shift amount) of the image sensor 102b during imaging of the captured image acquired in step S111. In this embodiment, the moving amount of the image sensor 102b is a shift between the optical axis position and the image center position. The optical axis position is the coordinate on the imaging surface where the luminance value is at its peak in a case where parallel light of uniform luminance enters the optical system 102a. The optical axis position may also be an intersection of the optical axis on the designed value and the imaging surface. The moving amount of the image sensor 102b may be acquired from the image pickup apparatus 102 or the image sensor 102b, or may be acquired from the imaging information accompanying the captured image. The moving amount of the image sensor 102b in this embodiment is an average position during the exposure time in the imaging. The shift between the average position during the exposure time and the optical axis position is calculated in each of the X-axis direction and the Y-axis direction, respectively. The moving amount of the image sensor 102b may be either the actual distance or a pixel-converted value. In this embodiment, the moving amount is the average position, but this embodiment is not limited to this example, and may use other indices such as the median and the mode.

In step S113, first, the divider 103e divides the captured image into a plurality of quadrant images (first partial images) (first division step). As illustrated in FIGS. 5A and 5B, in a case where image sensor 102b moves, the image center and the optical axis position differ, and therefore the captured image may be divided so as to include the optical axis position.

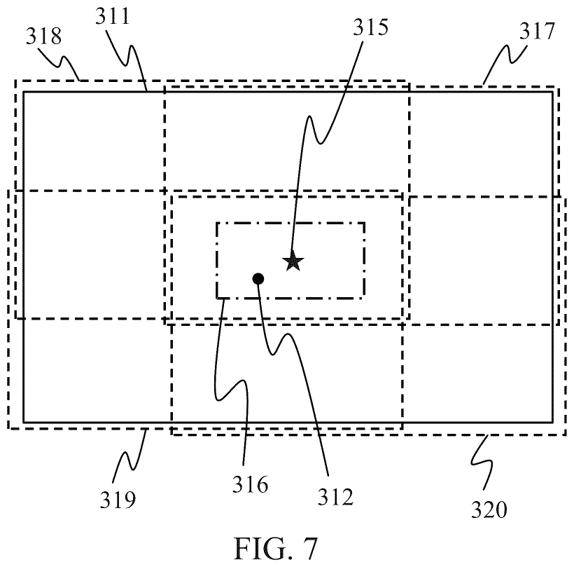

FIG. 7 explains a quadrant image. The four rectangles indicated by dotted lines represent a first quadrant image 317, a second quadrant image 318, a third quadrant image 319, and a fourth quadrant image 320. A solid line represents a captured image 311, a black dot and star represent the optical axis position 312 and the image center 315, respectively, and an alternate long and short dash line rectangle represents a possible range 316 of the optical axis position 312 in the captured image 311 (moving range of image sensor 102b). In a case where a moving amount of image sensor 102b in the X-axis direction is maximized, the optical axis position 312 is located on the short side of the range 316 in FIG. 7. In a case where the moving amount in the Y-axis direction of the image sensor 102b is maximized, the optical axis position 312 is located on the long side of the range 316 in FIG. 7. In this embodiment, the size of the quadrant image is determined so that the range 316 in FIG. 7 is included in each quadrant image. More specifically, size Wq of the quadrant image in the X-axis direction is expressed as follows:

$$Wq = Wi + Wo + α \qquad ( 1 )$$

where Wi is a size of the captured image 311 in the X-axis direction, Wo is a size of the range 316 in the X-axis direction, and α is a margin.

Similarly, size Hq of the quadrant image in the Y-axis direction is as follows:

$$Hq = Hi + Ho + α \qquad ( 2 )$$

where Hi is a size of the captured image 311 in the Y-axis direction, Ho is a size of the range 316 in the Y-axis direction, and α is the margin.

In this embodiment, the margin α is 64 pixels, but this is not limited to this example and can be changed to an arbitrary value. The margin α represents an overlap area when an image is divided, and is provided to reduce the influence of errors at the edges in the convolution processing in the subsequent correction processing. Increasing the margin α can reduce the errors at the edges, but increase a calculation amount accordingly. Therefore, it may be set properly according to the number of layers of the CNN, etc. Also, the margin α is set to the same value in both equations (1) and (2), but the margin α in the X-axis direction and the margin α in the Y-axis direction may be different.

In this step, the four quadrant images generated have the same image size. Thereby, the memory size for calculation can be fixed, and the memory management can become easier and the calculation speed can be improved. The four quadrant images may not have the same image size, and may be different according to another condition.

Next, the inverter 103d inverts each quadrant image. Since the first quadrant image 317 does not require inversion processing, it is performed for the other quadrant images. The second quadrant image 318 is inverted in the Y-axis direction, the fourth quadrant image 320 is inverted in the X-axis direction, and the third quadrant image 319 is inverted in both the X-axis direction and the Y-axis direction. Due to this inversion processing, the correction data for the first quadrant can be applied to each quadrant image.

In step S114, the divider 103e divides the quadrant image into a plurality of patch images (second partial images) (second division step). In a case where a single quadrant image is divided into M parts in the X-axis direction and N parts in the Y-axis direction, the number of patches per quadrant image is M×N. In this embodiment, since the captured image is divided into four quadrant images in step S113, the total number of patches generated in step S114 is 4×M×N. The image size of the patch image does not have to match the size for training. A margin may be provided during division. Setting the margin and excluding the margin during combination can reduce the influence of errors at the edges of the patch images generated during the convolution processing.

In step S115, the corrector 103c performs the correction processing for the plurality of patch images generated in step S114 based on the weights of the machine learning model acquired in step S111. In the correction processing in step S115, the network illustrated in FIG. 4 that was used for training is used, and each patch image generated in step S114 is input instead of the training patch 212 in FIG. 4. The correction processing is executed through the network illustrated in FIG. 4, and a correction patch image (first partial output image) corresponding to each patch image is generated.

In step S116, the combiner 103f combines the correction patch images generated in step S115 (first combining processing). The combining processing is basically executed in the reverse order of the division processing, and M×N correction patch images are combined to generate a single correction quadrant image (partial output image). Repeating this combining processing four times can generate all correction quadrant images. In combination, the margin set in step S114 is excluded from the correction patch images before the combining processing. Thereby, correction errors at the edges of the correction patch images can be reduced. This embodiment executes a combining method after exclusion (trimming), but may perform combination using weighted addition or weighted averaging without exclusion to make the boundaries between the correction patch images less noticeable. This embodiment will use a weighted average, but the disclosure is not limited to this example.

In step S117, the combiner 103f combines the corrected quadrant images generated in step S116 (second combining step). First, the inverter 103d performs the inversion processing for each corrected quadrant image. The corrected quadrant image corresponding to the second quadrant is inverted in the Y-axis direction, and the corrected quadrant image corresponding to the fourth quadrant is inverted in the X-axis direction. The corrected quadrant image corresponding to the third quadrant is inverted in the X-axis and Y-axis directions. The corrected quadrant image corresponding to the first quadrant is not inverted.

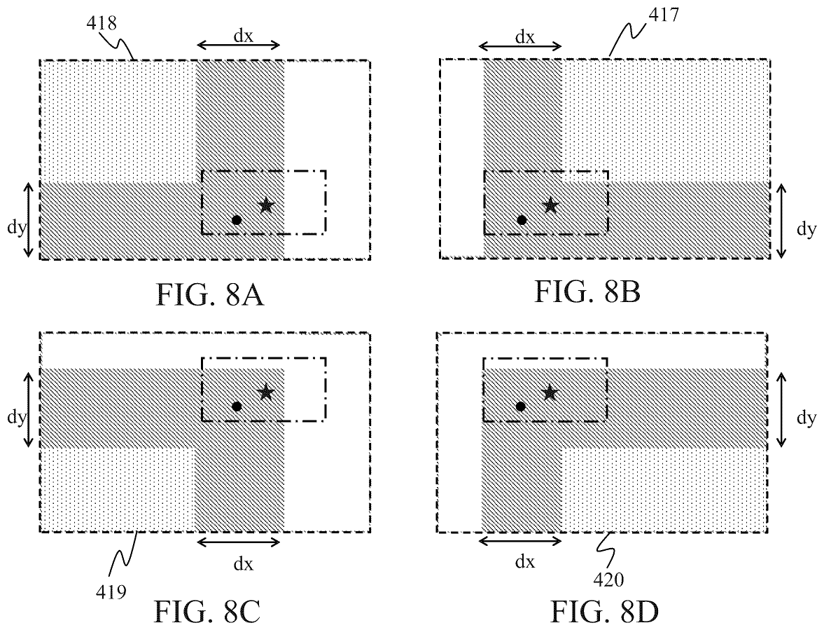

FIGS. 8A, 8B, 8C, and 8D illustrate the corrected quadrant images after inversion processing. FIGS. 8A, 8B, 8C, and 8D correspond to the second quadrant, first quadrant, third quadrant, and fourth quadrant, respectively. Dotted rectangles 417, 418, 419, and 420 represent the respective correction quadrant images, an alternate long and short dash line rectangle represents the possible range of the optical axis position, a star represents the image center, and a black dot represents the optical axis position. In FIGS. 8A, 8B, 8C, and 8D, a hatched area represents an area that overlaps another correction quadrant image during the combination processing (overlapping area), and a dotted area represents an area that does not overlap another correction quadrant image and is used as a correction image. dx and dy represent overlapping widths in the X-axis direction and the Y-axis direction, respectively. The overlapping widths dx and dy may be the same or different. The combination processing according to this embodiment combines the correction quadrant images so that the optical axis positions overlap each other. In the hatched areas, which are the overlapping areas, a weighted average is performed according to a distance. That is, for example, in a case where the hatched area is near the dotted area of the correction quadrant image 417, the weight of the correction quadrant image 417 is increased. This weighted averaging makes the boundary of the correction quadrant image less noticeable, and can improve the quality of the correction image. To simplify the processing, the overlapping parts of four corrected quadrant images may be weighted at 0.25, and the overlapping parts of two corrected quadrant images may be weighted at 0.5.

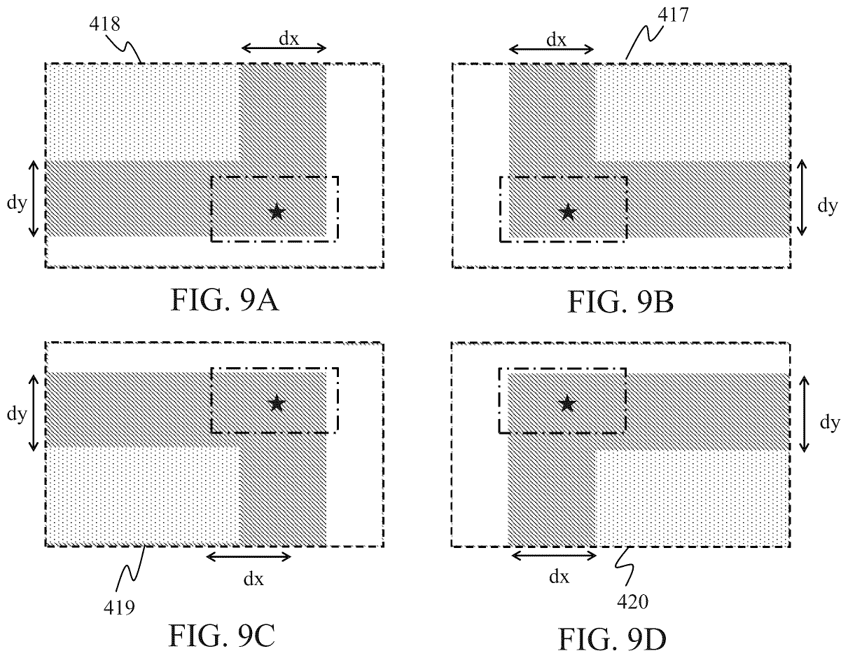

FIGS. 9A, 9B, 9C, and 9D illustrate corrected quadrant images in a case where the image sensor 102b does not move. In a case where the image sensor 102b does not move, the image center and the optical axis coincide with each other, so the optical axis position is omitted. Dots in FIGS. 8A, 8B, 8C, and 8D differ according to the quadrant, but dots in FIGS. 9A, 9B, 9C, and 9D have the same size between quadrants. The overlapping areas of the hatched areas in FIGS. 9A, 9B, 9C, and 9D are determined only by the set values of the overlap widths dx and dy. On the other hand, in a case where the image sensor 102b moves and is combined based on the optical axis position as in FIGS. 8A, 8B, 8C, and 8D, the overlapping area also changes depending on the optical axis position. Thus, compared to the case where the movement of the image sensor 102b is not taken into consideration as in FIGS. 9A, 9B, 9C, and 9D, the disclosure is different in that the area relating to the combining processing indicated by the hatched portion and dotted portion depends on the optical axis position.

In step S118, the combiner 103f outputs the captured image in which the blurs due to aberration and diffraction have been corrected, using the image combined in step S117 as a corrected image. Since the estimated image in the machine learning model that is used for this embodiment is also a raw image, development processing is performed, as necessary. In this embodiment, the development processing includes gamma correction, white balance correction, and demosaicing. In creating a corrected image, a moving amount of the image sensor 102b, etc. may be attached as meta information on the image.

The corrected-image generation processing according to this embodiment has been discussed. This embodiment divides the captured image into the quadrant size including the optical axis position, and combines the corrected quadrant images based on the optical axis position. Due to this method, even if the captured image is one in which the image sensor 102b has moved, a corrected image with a high correction effect that considers the influence of the misalignment of the optical axis can be obtained. In dividing the captured image, the quadrant size is set to include the moving range of the image sensor 102b, so that processing can be performed independently of the captured image. Thereby, memory management becomes easy and the calculation speed is improved.

This embodiment divides the quadrant image into a plurality of patch images in step S114, and performs the correction processing for the plurality of patch images, which are the plurality of partial images, in step S115, but the disclosure is not limited to this example. The correction processing may be performed for the plurality of quadrant images without dividing the quadrant image into patch images. That is, the correction processing may be performed for the plurality of quadrant images generated in step S113 as a plurality of partial images without executing the processing of step S114. In this case, since the correction patch image is not generated, there is no need to execute the processing of step S116, and the processing of step S117 may be executed using the plurality of correction quadrant images generated by executing the correction processing on the plurality of quadrant images. This is similarly applicable to second and third embodiments.

As described above, the configuration according to this embodiment can provide a high correction effect even for a captured image obtained by capturing an image while the image sensor 102b moves.

### Second Embodiment

This embodiment executes corrected-image generation processing different from that in the first embodiment using an image estimator in the image pickup apparatus.

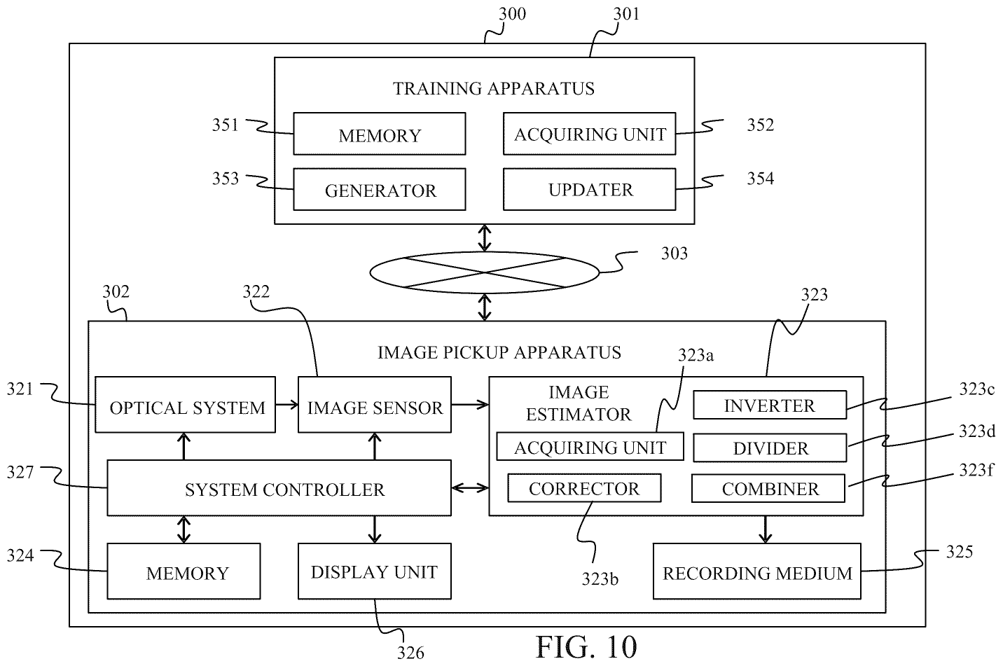

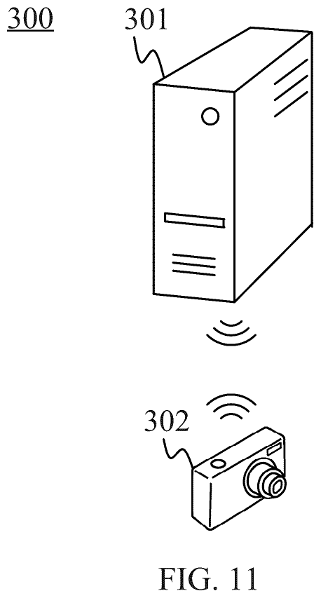

FIG. 10 is a block diagram of an image processing system 300 according to this embodiment. FIG. 11 is an external view of the image processing system 300. The image processing system 300 includes a training apparatus (image processing apparatus) 301 and an image pickup apparatus 302 connected via a network 303. The training apparatus 301 includes a memory 351, an acquiring unit 352, a generator 353, and an updater 354, and updates weights (weight information) to perform training of a neural network for blur correction (deblurring). The image pickup apparatus 302 captures an object space to acquire a captured image, generates an estimated image from the captured image using the read weight information, and generates a corrected image by weighted addition of the captured image and the estimated image. The image pickup apparatus 302 includes an optical system 321 and an image sensor 322. An image estimator 323 includes an acquiring unit 323a, a corrector 323b, an inverter 323c, a divider 323d, and a combiner 323e, and executes estimation processing for the captured image using weight information stored in a memory 324.

The weight information was previously updated by the training apparatus 301 and stored in the memory 351. The image pickup apparatus 302 reads out the weight information from the memory 351 via the network 303 and stores it in the memory 324. The corrected image generated using the captured image and the estimated image is stored in a recording medium 325. In a case where an instruction is given from the user regarding the display of the corrected image, the stored corrected image is read out and displayed on a display unit 326. The captured image already stored in the recording medium 325 may be read out and corrected by the image estimator 323. The above series of controls is performed by a system controller 327.

The training method according to this embodiment for the machine learning model executed by the training apparatus 301 is similar to that of the first embodiment, and thus a description thereof will be omitted.

The corrected-image generation processing executed by the image estimator 323 according to this embodiment will be described below. The corrected-image generation processing according to this embodiment differs from the corrected-image generation processing according to the first embodiment only in the part where the quadrant image is generated in step S113. Thus, this embodiment will discuss a method of generating a quadrant image. The other processing is similar to that of the first embodiment, and thus a description thereof will be omitted.

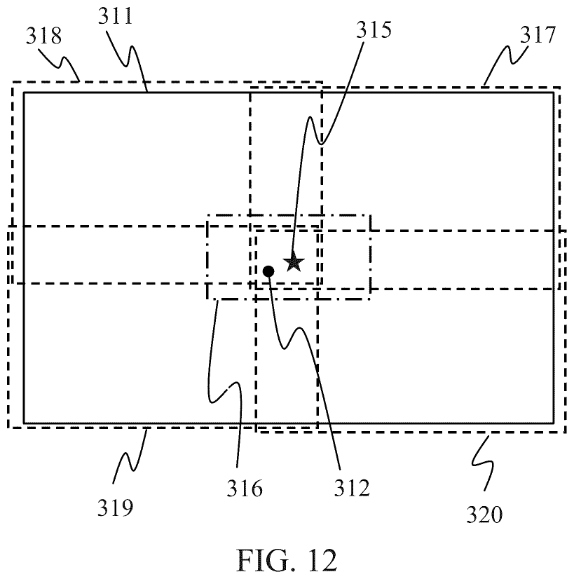

A description will now be given of captured-image dividing processing according to this embodiment. The divider 323d divides a captured image into a plurality of quadrant images. FIG. 12 illustrates the quadrant images in this embodiment. The four rectangles indicated by dotted lines respectively represent a first quadrant image 317, a second quadrant image 318, a third quadrant image 319, and a fourth quadrant image 320. A solid line indicates a captured image 311, a black dot and a star respectively indicate an optical axis position 312 and an image center 315, and an alternate long and short dash line rectangle indicates a possible range 316 of the optical axis position 312 in the captured image 311. In a case where a moving amount of the image sensor 322 in the X-axis direction is maximum, the optical axis position 312 is located on the short side of the range 316 in FIG. 12. In a case where a moving amount of the image sensor 322 in the Y-axis direction is maximum, the optical axis position 312 is located on the long side of the range 316 in FIG. 12. In this embodiment, the size of the quadrant image is determined based on the moving amount of the image sensor 322 acquired by the acquiring unit 323a or the optical axis position 312. As illustrated in FIG. 12, the captured image is divided so that the optical axis position 312 is included in each quadrant image. At this time, the image may be divided by leaving a little margin rather than dividing the image by the optical axis position 312. This can reduce the influence of correction errors in the edge processing during the convolution processing in the correction processing at the later stage. Compared to the division processing according to the first embodiment illustrated in FIG. 7, in a case where the width of the margin is the same, the quadrant size is reduced by using the optical axis position as the reference for division, and the overlapping area of the quadrant images can also be narrowed.

The post-division steps of the quadrant image are similar to those in the first embodiment, and thus a description will be omitted. This embodiment differs from the first embodiment in that the optical axis position 312 of the captured image is used as a reference both for division of the quadrant image and for combination of the correction patch images to generate the corrected quadrant image. This may complicate memory management because the size of the quadrant image changes according to a moving amount of the image sensor 322, but a calculation amount during correction can be reduced because the quadrant image size is minimum.

As described above, the configuration according to this embodiment can provide a high correction effect even for a captured image obtained by capturing an image while the image sensor 102b moves.

### Third Embodiment

The image processing system according to this embodiment differs from that of each of the first and second embodiments in that it has a processing apparatus (computer) that transmits a captured image to be processed to the image estimation apparatus and receives the processed output image (corrected image) from the image estimation apparatus.

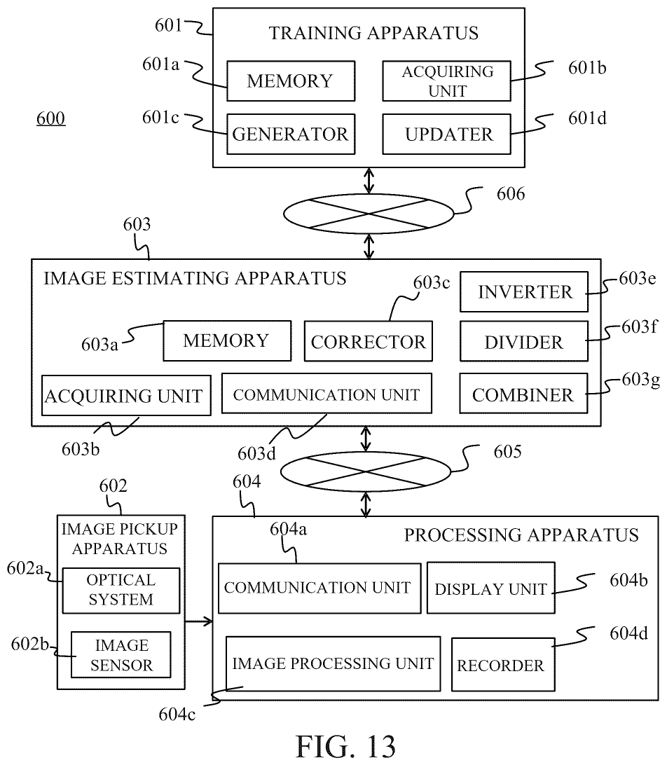

FIG. 13 is a block diagram of an image processing system 600 according to this embodiment. The image processing system 600 includes a training apparatus 601, an image pickup apparatus 602, an image estimation apparatus 603, and a processing apparatus 604. The training apparatus 601 and the image estimation apparatus 603 are, for example, a server. The processing apparatus 604 includes, for example, a user terminal (personal computer or smartphone). The processing apparatus 604 is connected to the image estimation apparatus 603 via a network 605. The image estimation apparatus 603 is connected to the training apparatus 601 via a network 606. That is, the processing apparatus 604 and the image estimation apparatus 603 can communicate with each other, and the image estimation apparatus 603 and the training apparatus 601 can communicate with each other.

The training apparatus 601 includes a memory 601a, an acquiring unit 601b, a generator 601c, and an updater 601d. The configuration of the training apparatus 601 is similar to that of the training apparatus 101 according to the first embodiment, and thus a description thereof will be omitted. The image pickup apparatus 602 includes an optical system 602a and an image sensor 602b. The configuration of the image pickup apparatus 602 is similar to that of the image pickup apparatus 102 according to the first embodiment, and thus a description thereof will be omitted.

The image estimation apparatus 603 includes a memory 603a, an acquiring unit 603b, a corrector 603c, a communication unit (receiver) 603d, an inverter 603e, a divider 603f, and a combiner 603g. The memory 603a, the acquiring unit 603b, the corrector 603c, the inverter 603e, the divider 603f, and the combiner 603g are similar to the memory 103a, the acquiring unit 103b, the corrector 103c, the inverter 103d, the divider 103e, and the combiner 103f of the first embodiment, respectively. The communication unit 603d has a function of receiving a request transmitted from the processing apparatus 604, and a function of transmitting an output image generated by the image estimation apparatus 603 to the processing apparatus 604.

The processing apparatus 604 includes a communication unit (transmitter) 604a, a display unit 604b, an image processing unit 604c, and a recorder 604d. The communication unit 604a has a function of transmitting a request to the image estimation apparatus 603 to cause the image estimation apparatus 603 to execute processing for the captured image, and a function of receiving an output image processed by the image estimation apparatus 603. The display unit 604b has a function of displaying various information. The information displayed by the display unit 604b includes, for example, the captured image to be transmitted to the image estimation apparatus 603 and the output image received from the image estimation apparatus 603. The image processing unit 604c has a function of further performing image processing for the output image received from the image estimation apparatus 603. The recorder 604d records the captured image acquired from the image pickup apparatus 602, the output image received from the image estimation apparatus 603, etc.

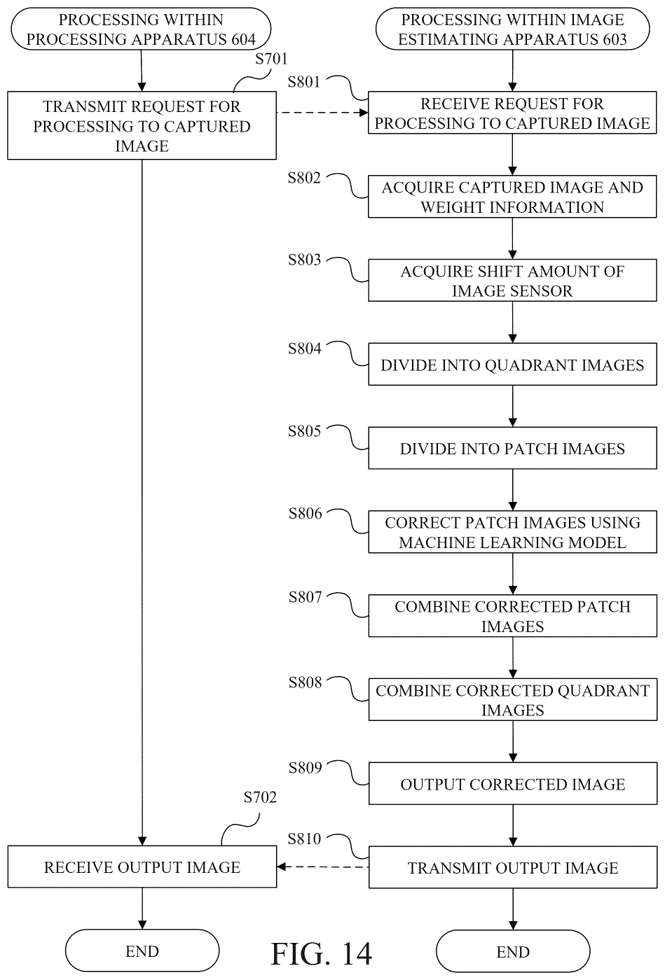

A description will be given of the corrected-image generation processing according to this embodiment. FIG. 14 is a flowchart illustrating the corrected-image generation processing according to this embodiment. The flow of FIG. 14 is started when a user issues an instruction to start the corrected-image generation processing via the processing apparatus 604. First, the operation of the processing apparatus 604 will be described.

In step S701, the processing apparatus 604 transmits a processing request for a captured image (a request for executing processing to correct the image) to the image estimation apparatus 603. The captured image to be processed may be transmitted to the image estimation apparatus 603 by any method. For example, the captured image may be uploaded to the image estimation apparatus 603 at the same time as step S701, or may be uploaded to the image estimation apparatus 603 before step S701. The captured image may be an image stored on a server different from the image estimation apparatus 603. In step S701, the processing apparatus 604 may transmit ID information for authenticating a user together with the request for processing the captured image.

In step $702, the processing apparatus 604 receives an output image generated in the image estimation apparatus 603. The output image is a corrected image obtained by weighted addition of the captured image and the estimated image, as in the first embodiment.

Next follows a description of the operation of the image estimation apparatus 603. The corrected-image generation processing according to this embodiment differs from that of each of the first and second embodiments in that processing is performed for a plurality of captured images.

In step S801, the image estimation apparatus 603 receives a request for processing the captured image transmitted from the processing apparatus 604. The image estimation apparatus 603 determines that the correction processing for the captured image has been instructed, and executes the processing from step S802 onwards.

In step S802, the image estimation apparatus 603 acquires the captured image and weight information. The weight information is acquired in a similar manner to that of the first embodiment. The captured image is an undeveloped raw image, similar to the learning image, and in this example, it is transmitted from the image pickup apparatus 602. The weight information is transmitted from the training apparatus 601 and stored in the memory 603a. The weight information may be acquired directly from the training apparatus 601. This embodiment acquires a plurality of captured images. Multiple pieces of weight information may also be acquired. The weight information and network may be changed according to the captured image and the moving amount of the image sensor 602b.

In step S803, the acquiring unit 603b acquires a moving amount (shift amount) of the image sensor 602b during imaging of the captured image acquired in step S802. In this embodiment, the moving amount of the image sensor 602b is a shift between the optical axis position and the image center position. The optical axis position is the coordinate on the imaging surface where the luminance value is the peak when parallel light of uniform luminance is incident on the optical system 602a. The optical axis position may also be an intersection point on the imaging surface of the optical axis on the designed value. The moving amount of the image sensor 602b may be acquired from the image pickup apparatus 602 or the image sensor 602b, or may be acquired from the imaging information attached to the captured image. In this embodiment, the moving amount of the image sensor 602b is the average position during the exposure in imaging. The deviation between the average position during the exposure time and the optical axis position is calculated in the X-axis direction and the Y-axis direction. Either an actual distance or a pixel-converted value may be used as the moving amount of the image sensor 602b. In this embodiment, the moving amount is an average position, but this embodiment is not limited to this example, and other indices such as the median or the mode may be used. In a case where the information acquired by the acquiring unit 603b is in units of length such as mm or cm, the moving amount of the image sensor 602b may be converted to a pixel pitch. In a case where a fraction occurs during conversion, processing such as rounding or truncation may be performed.

In step S804, the divider 603f divides the captured image into a plurality of quadrant images (first partial images) (first division step). As illustrated in FIGS. 5A and 5B, in a case where the image sensor 602b moves, the image center and the optical axis position differ, so the captured image may be divided so as to include the optical axis position. This embodiment performs division based on the maximum moving amount of the image sensor 602b acquired in step S803. In other words, in the captured image with the maximum moving amount, division processing is performed so as to include the optical axis position for all quadrant images. The first embodiment divides the image sensor 102b to include the movable range, while this embodiment divides the image sensor 102b to include the optical axis position for a plurality of captured images to be corrected. Thus, the size of the quadrant image can be reduced compared to the first embodiment. Since the size of the quadrant image is fixed initially for the plurality of captured images, the memory management is easier than that in the second embodiment.

Steps S805 to S809 are similar to steps S114 to S118 in the first embodiment, and thus a description thereof will be omitted.

In step S810, the image estimation apparatus 603 transmits the output image to the processing apparatus 604. In a case where the corrected-image generation processing is performed within the image estimation apparatus 603 as in this embodiment, the processing load due to the correction processing can be borne within the image estimation apparatus 603, and thus the processing capacity required for the processing apparatus 604 can be reduced.

As described above, the configuration according to this embodiment can provide a high correction effect even for captured images obtained by capturing images while the image sensor 602b moves.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or a storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-174538, which was filed on Oct. 3, 2024, and which is hereby incorporated by reference herein in its entirety.

What is claimed is:

1. An image processing method for processing an image obtained via an optical system and an image sensor, the image processing method comprising:
acquiring a moving amount of the image sensor;
generating a plurality of first partial images which include an optical axis position obtained by dividing the image;
generating a plurality of partial output images based on first partial images using a neural network; and
generating an output image by combining the plurality of partial output images using the moving amount.

2. The image processing method according to claim 1, wherein the plurality of partial output images include overlapping areas that overlap each other, and
wherein a position of an overlapping area is based on the moving amount.

3. The image processing method according to claim 2, wherein the plurality of partial output images are combined by combining the overlapping areas.

4. The image processing method according to claim 1, wherein a size of each of the plurality of first partial images is set independently of the moving amount.

5. The image processing method according to claim 1, wherein a size of each of the plurality of first partial images is set based on a moving range of the image sensor.

6. The image processing method according to claim 1, further comprising generating a plurality of second partial images obtained by dividing the plurality of first partial images.

7. The image processing method according to claim 1, wherein the partial output images are generated by combining the plurality of first partial output images.

8. The image processing method according to claim 1, wherein a size of each of the plurality of first partial images is set based on the moving amount.

9. The image processing method according to claim 1, wherein a size of each of the plurality of first partial images is set based on a maximum moving amount among a plurality of moving amounts corresponding to a plurality of images.

10. The image processing method according to claim 6, further comprising inverting at least one of the plurality of second partial images, and then inputting the plurality of second partial images into the neural network.

11. The image processing method according to claim 6, wherein the plurality of second partial images have the same size.

12. The image processing method according to claim 1, wherein the plurality of partial output images have the same size.

13. An image processing apparatus configured to correct an image obtained via an optical system and an image sensor using a neural network, the image processing apparatus comprising:
one or more memories storing instructions; and
one or more processors that, upon execution of the instructions, operate to:
acquire a moving amount of the image sensor;
generate a plurality of first partial images which include an optical axis position obtained by dividing the image;
generate a plurality of partial output images based on first partial images using a neural network; and
generate an output image by combining the plurality of partial output images using the moving amount.

14. An image processing system comprising:
the image processing apparatus according to claim 13;
a processing apparatus that includes a transmitter configured to transmit a request to the image processing apparatus to request the image processing apparatus to perform processing for the image and generate the output image.

15. A non-transitory computer-readable storage medium storing a program that causes a computer to execute the image processing method according to claim 1.
